(19) United States
(12) Patent Application Publication
(10) Pub. No.: US 2008/0245814 A1
(43) Pub. Date: Oct. 9, 2008

(54) Device for dispensing tongue depressors

(76) Inventors: Mark Rogow, Wantaugh, NY (US); John Mattera, E. Setauket, NY (US)

Correspondence Address: ILYA ZBOROVSKY, 6 Schoolhouse Way, Dix Hills, NY, 11746, US

(21) Appl. No.: 11/732,821

(22) Filed: Apr. 5, 2007

(51) Int. Cl. B65G 59/00

(52) U.S. Cl. 221/268; 221/276

(57) ABSTRACT

A device for dispensing tongue dispensers has housing forming an inner chamber for accommodating a plurality of tongue depressors arranged in stack and having a dispensing opening, a unit for displacing the stack as a whole so as to move one of the tongue depressors in the stack to a dispensing position, and an inclined guiding unit guiding the one tongue depressor from the dispensing position through the opening so as to extend at least partially outside to be grasped by a user.

### BACKGROUND OF THE INVENTION

The present invention relates to a device for dispensing tongue depressors.

It is known to store tongue depressors in containers in which the tongue depressors are accommodated to be accessible for a user. When a user takes one of the tongue depressors from such a container, he can contaminate the remaining tongue depressors. It is therefore believed to be advisable to provide a tongue dispensing device which eliminates the disadvantages of the prior art and assures individual dispensing of a tongue depressor without contact of a user with other tongue depressors at the same time.

### SUMMARY OF THE INVENTION

Accordingly, it is an object of the present invention to provide a device for dispensing tongue depressors which eliminates the disadvantages of the prior art.

In keeping with these objects and with others which will become apparent hereinafter, one feature of the present invention resides, briefly stated, a device for dispensing tongue depressor, comprising housing forming a chamber for accommodating a plurality of tongue depressors arranged in stack and having a dispensing opening; means for displacing said stack as a whole so as to move one of the tongue depressors in said stack to a dispensing position; and inclined guiding means guiding said one tongue depressor from said dispensing position through said opening so as to extend at least partially outside to be grasped by a user.

When the device for dispensing tongue depressors is designed in accordance with the present invention, it allows dispensing only one of the tongue depressors at a time, while all other tongue depressors are accommodated inside the housing of the device. Therefore an orderly dispersion of tongue depressors is provided one by one without contaminating other tongue depressors.

In accordance with another feature of the present invention, said means for displacing said stack as a whole include spring means having one end abutting against said housing and another end adapted to abut against said stack.

In accordance with still a further feature of the present invention, a supporting element is provided configured to support said stack of tongue depressors, and said spring means acting on said supporting element.

In accordance with a further feature of the present invention, said spring means include at least one spring element.

In accordance with still a further feature of the present invention, said guiding means include an inclined element arranged at an angle to a horizontal plane such that said one tongue depressor is deviated from the horizontal plane and displaced transversely to a direction in which said tongue depressors are arranged over one another in said stack.

In accordance with still a further feature of the present invention, said housing has a plurality of walls including a bottom wall, a top wall, and side walls, and said dispensing opening is provided in said top wall.

In accordance with another feature of the present invention, said housing has a plurality of walls including a bottom wall, a top wall, and side walls, and said top wall is hingedly connected with one of said side walls and movable between a closed position in which said inner chamber is closed and an open position in which said inner chamber is open for placing the tongue depressors into said inner chamber.

In accordance with another feature of the present invention, said housing has a plurality of walls including a bottom wall, a top wall, and side walls, and said top wall is hingedly connected with one of said side walls and movable between a closed position in which the inner chamber is closed and an open position in which said inner chamber is open for placing the tongue depressors into said inner chamber.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view showing an elevation view in a cross-section of a dispensing device for dispensing tongue depressors in accordance with the present invention; and

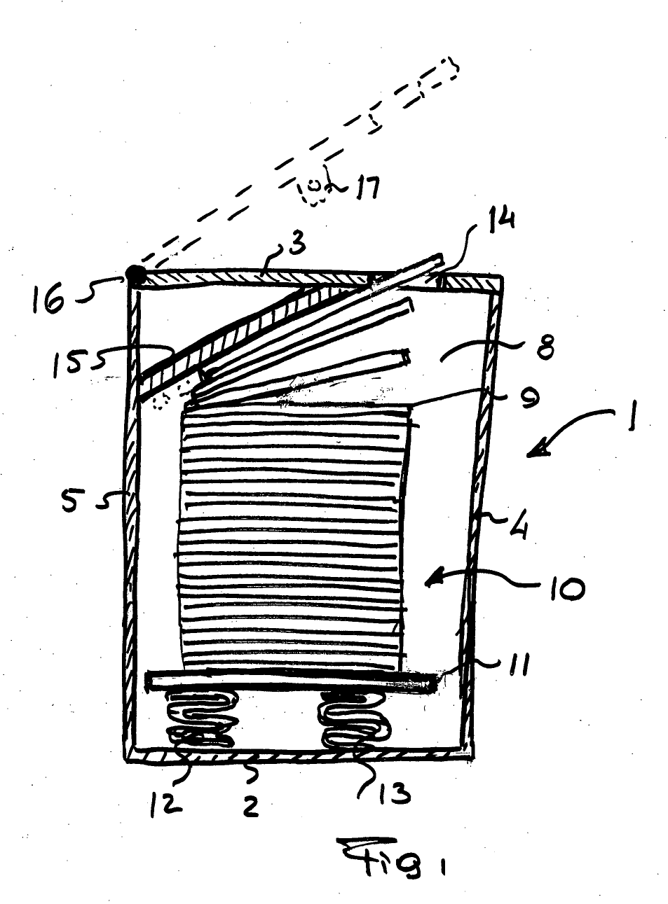

FIG. 2 is a partial perspective view of the device for dispensing tongue depressors in accordance with the present invention.

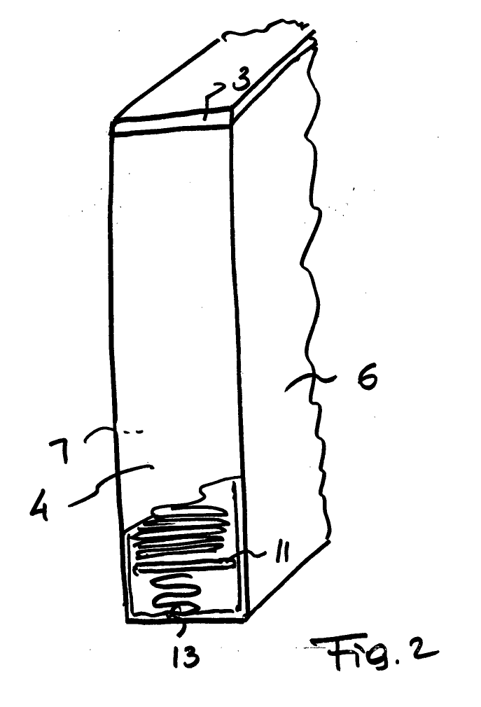

### DESCRIPTION OF THE PREFERRED EMBODIMENTS

A device for dispensing tongue depressors in accordance with the present invention has a housing which is identified as a whole with reference numeral 1. The housing 1 has a bottom wall 2, a top wall 3, and side walls 4, 5, 6, 7.

The side walls 4 and 5 are narrow walls, while the side walls 6 and 7 are wide walls so as to form an inner chamber 8 substantially corresponding to a size of tongue depressors. The inner chamber 8, which is formed by the above mentioned side walls, is therefore elongated and has inner transverse dimensions which are slightly greater than a length and a width of a single tongue depressor.

Tongue depressors are identified with reference numeral 9. They are introduced into the inner chamber 8 of the housing to be arranged in a stack 10 one on top of the other.

The device is provided with means for displacing the whole stack 10 of the tongue depressors 9 so as to move one of the tongue depressors, in particular the uppermost one tongue depressor, to a dispensing position. The displacing means include a supporting platform 11 on which the stack 10 of the tongue depressors 9 is placed, and spring means which can include one or two springs 12 and 13. The springs 12 and 13 have one end abutting against the bottom wall 2 of the housing and another opposite end abutting against the lower surface of the platform 11, so as to spring bias the platform 11 and the stack 10 of the tongue depressors 9 arranged on it upwardly. As a result, the uppermost tongue depressor 9 is moved upwardly to a dispensing position.

The housing 1 has a dispensing opening which is identified with reference numeral 14. In the shown embodiment the dispensing opening 14 is provided in the top wall 3 of the housing 1, as an exemplary embodiment.

Means is further provided for guiding the tongue depressor, in particular the uppermost tongue depressor 9 from the stack 10 into the dispensing opening 14. The guiding means is identified with reference numeral 15 and can include an inclined element or ramp 15.

The top wall 3 can be formed as a cover for the inner chamber 8. For this purpose, it can be pivotally connected by a hinge 16 to a side wall 5 and movable between the position shown in solid lines in which it closes the inner chamber 8, and a position shown in dotted lines in which it opens the inner chamber 8 for introducing the stack 10 of the tongue depressors 9 into the inner chamber 8. In the shown embodiment the top wall 3 simultaneously forms a cover of the device and is provided with the dispensing opening, thus performing two important functions. The top wall 3 which forms the cover is further provided with clasps 17 to lock it to the remaining part of the housing 1.

The device for dispensing tongue depressors in accordance with the present invention operates in the following manner.

The stack 10 of tongue depressors is introduced into the inner chamber 8 of the device and placed on the supporting platform 11. The stack 10 is always pressed by the springs 12 and 13 upwardly. At the same time, the uppermost tongue depressor 9 comes in contact with the inclined guiding element 15, is turned by it, and its right end in the drawings is guided into and through the dispensing opening 14 so as to be partially exposed outside. A user can grasp this end of the tongue depressor and remove it from the housing. At this point, the next tongue depressor assumes the same position, namely its one end extends outwardly beyond the housing to be grasped by a user again.

Means can be provided for improving guidance of the tongue depressors by the inclined element 15. For example, the lower surface of the inclined element 15 can be polished to impart a sliding property to it. Also, rolling elements, such as bearings or wheels can be provided on the lower surface of the guiding element 15.

It will be understood that each of the elements described above, or two or more together, may also find a useful application in other types of constructions differing from the types described above.

While the invention has been illustrated and described as embodied in a device for dispensing tongue depressors, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A device for dispensing tongue depressors, comprising housing forming an inner chamber for accommodating a plurality of tongue depressors arranged in stack and having a dispensing opening; means for displacing a said stack as a whole so as to move one of the tongue depressors in said stack to a dispensing position; and inclined guiding means guiding said one tongue depressor from said dispensing position through said opening so as to extend at least partially outside to be grasped by a user.

2. A device as defined in claim 1, wherein said means for displacing said stack as a whole include spring means having one end abutting against said housing and another end adapted to abut against said stack.

3. A device as defined in claim 2; and further comprising a supporting element configured to support said stack of tongue depressors, said spring means acting on said supporting element.

4. A device as defined in claim 2, wherein said spring means include at least one spring element.

5. A device as defined in claim 1, wherein said guiding means include an inclined element arranged at an angle to a horizontal plane such that said one tongue depressor is deviated from the horizontal plane and displaced transversely to a direction in which said tongue depressors are arranged over one another in said stack.

6. A device as defined in claim 1, wherein said housing has a plurality of walls including a bottom wall, a top wall, and side walls, said dispensing opening being provided in said top wall.

7. A device as defined in claim 1, wherein said housing has a plurality of walls including a bottom wall, a top wall, and side walls, said top wall being hingedly connected with one of said side walls and movable between a closed position in which said inner chamber is closed and an open position in which said inner chamber is open for placing the tongue depressors into said inner chamber.

8. A device as defined in claim 6, wherein said housing has a plurality of walls including a bottom wall, a top wall, and side walls, said top wall being hingedly connected with one of said side walls and movable between a closed position in which a chamber is closed and an open position in which said inner chamber is open for placing the tongue depressors into said inner chamber.

9. A device as defined in claim 1, wherein said guiding means has a surface enhancing means for tongue depressors, said enhancing means being formed as means selected from the group consisting of a polished surface and a rolling element.
